(19) United States
(12) Patent Application Publication
(10) Pub. No.: US 2025/0192180 A1
(43) Pub. Date: Jun. 12, 2025

(54) POSITIVE ELECTRODES COMPRISING VINYLIDENE FLUORIDE AND PERFLUORINATED OLEFIN COPOLYMER-CONTAINING BINDERS FOR BATTERIES THAT CYCLE LITHIUM IONS

(71) Applicant: GM GLOBAL TECHNOLOGY OPERATIONS LLC, Detroit, MI (US)

(72) Inventors: Chuanlong WANG, Troy, MI (US); Xiaowei YU, Farmington Hills, MI (US); Roland J. KOESTNER, Webster, NY (US); Bradley R. FRIEBERG, Farmington Hills, MI (US); Xiaosong HUANG, Novi, MI (US)

(21) Appl. No.: 18/532,561

(22) Filed: Dec. 7, 2023

(51) Int. Cl. H01M 4/62; H01M 4/02; H01M 4/04; H01M 4/583; H01M 10/0525

(52) U.S. Cl. CPC H01M 4/623; H01M 4/0402; H01M 4/583; H01M 10/0525; H01M 2004/028

(57) ABSTRACT

A battery that cycles lithium ions includes a positive electrode including an electroactive positive electrode material and a polymer binder mixture. The polymer binder mixture includes a polyvinylidene fluoride (PVDF) homopolymer and a copolymer including vinylidene fluoride (VDF) monomers and at least one perfluorinated olefin monomer. The positive electrode may be manufactured by depositing a precursor mixture on a substrate at a temperature of less than or equal to 30 degrees Celsius to form a precursor layer. The precursor mixture may include the electroactive positive electrode material, the polymer binder mixture, and an organic solvent comprising γ-valerolactone, dihydrolevoglucosenone, cyclopentanone, or a combination thereof. The organic solvent may be removed from the precursor layer to form the positive electrode on the substrate.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to composite electrodes for batteries that cycle lithium ions, and more particularly to methods of manufacturing composite electrodes using green solvents.

Lithium batteries are used in a wide variety of electronic devices and are a promising candidate to fulfill the requirements of electric vehicles, including hybrid electric vehicles, owing to their high energy and power densities. Secondary lithium batteries generally include a negative electrode, a positive electrode, and an electrolyte that provides a medium for the conduction of lithium ions between the negative and positive electrodes during discharge and charge of the battery. During manufacture, the electrodes are oftentimes deposited in the form of thin layers on electrically conductive metal current collectors. The negative and positive electrode layers may have a composite structure comprising particles of an electrochemically active (electroactive) material embedded in a polymer binder. One example of a polymer binder that may be used to manufacture composite electrodes is polyvinylidene fluoride (PVDF).

Composite electrodes may be manufactured by depositing a slurry comprising the electroactive material particles and the polymer binder in a solvent on a substrate in the form of a continuous layer, followed by removal of the solvent. The polymer binder and the solvent are generally selected to avoid undesirable chemical reactions with the electroactive material and to ensure good solubility of the polymer binder in the solvent.

### SUMMARY

A battery that cycles lithium ions, according to one or more embodiments of the present disclosure, comprises a positive electrode comprising an electroactive material and a polymer binder mixture. The polymer binder mixture comprises a polyvinylidene fluoride (PVDF) homopolymer and a copolymer comprising vinylidene fluoride (VDF) monomers and at least one perfluorinated olefin monomer. The copolymer has the formula (1):

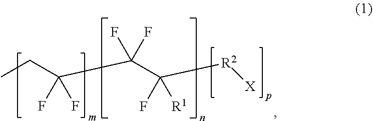

wherein:
m is greater than or equal to 3500 and less than or equal to 18000,
n is greater than or equal to 800 and less than or equal to 7500,
p is 1 or 0,
R¹ is F or a perfluorinated alkyl group,
R² is an alkylene group, and
X is an acidic functional group.

The copolymer may comprise poly(vinylidene fluoride-co-tetrafluoroethylene) (PVDF-TFE), poly(vinylidene fluoride-co-hexafluoropropylene) (PVDF-HFP), a copolymer of vinylidene fluoride, tetrafluoroethylene, and hexafluoropropylene (THV), or a combination thereof.

The X may be at least one acidic functional group selected from the group consisting of carboxyl (—C(═O)OH), sulfo (—S(═O)₂—OH), phosphono (—P(═O)(—OH)₂), nitro (—NO₂), and mercapto (—SH).

The copolymer may have an ion-exchange capacity of greater than or equal to 0.05 milliequivalents H⁺ per gram and less than or equal to 5 milliequivalents H₊ per gram.

A weight ratio of the PVDF homopolymer to the copolymer in the polymer binder mixture may be greater than or equal to 1:1 and less than or equal to 3:1.

The PVDF homopolymer may have a molecular weight of greater than or equal to 500 kilodaltons and less than or equal to 1500 kilodaltons, and the copolymer may have a molecular weight of greater than or equal to 500 kilodaltons and less than or equal to 1500 kilodaltons.

The polymer binder mixture may constitute, by weight, greater than or equal to 0.5% and less than or equal to 5% of the positive electrode.

The electroactive material may constitute, by weight, greater than or equal to 80% and less than or equal to 98% of the positive electrode.

The positive electrode may further comprise an electrochemically inactive, electrically conductive carbon-based material.

The battery may further comprise a negative electrode comprising an electroactive negative electrode material, and an electrolyte infiltrating the positive electrode and the negative electrode. In such case, the electrolyte may comprise a nonaqueous polar aprotic organic solvent and a lithium salt in the nonaqueous polar aprotic organic solvent.

A battery that cycles lithium ions, in accordance with one or more embodiments of the present disclosure, comprises a positive electrode comprising an electroactive material and a polymer binder mixture. The polymer binder mixture comprises a polyvinylidene fluoride (PVDF) homopolymer and a copolymer comprising poly(vinylidene fluoride-co-tetrafluoroethylene) (PVDF-TFE), poly(vinylidene fluoride-co-hexafluoropropylene) (PVDF-HFP), a copolymer of vinylidene fluoride, tetrafluoroethylene, and hexafluoropropylene (THV), or a combination thereof.

A weight ratio of the PVDF homopolymer to the copolymer in the polymer binder mixture may be greater than or equal to 1:1 and less than or equal to 3:1.

The PVDF homopolymer may have a molecular weight of greater than or equal to 500 kilodaltons and less than or equal to 1500 kilodaltons, and the copolymer may have a molecular weight of greater than or equal to 500 kilodaltons and less than or equal to 1500 kilodaltons.

The copolymer may comprise at least one acidic functional group selected from the group consisting of carboxyl (—C(═O)OH), sulfo (—S(═O)₂—OH), phosphono (—P(═O)(—OH)₂), nitro (—NO₂), and mercapto (—SH).

The polymer binder mixture may constitute, by weight, greater than or equal to 0.5% and less than or equal to 5% of the positive electrode. The electroactive material may constitute, by weight, greater than or equal to 80% and less than or equal to 98% of the positive electrode.

A method of manufacturing a positive electrode for a battery that cycles lithium ions, in accordance with one or more embodiments of the present disclosure, comprises depositing a precursor mixture on a substrate at a temperature of less than or equal to 30 degrees Celsius to form a precursor layer. The precursor mixture comprises an electroactive positive electrode material, a polymer binder mixture, and an organic solvent comprising γ-valerolactone, dihydrolevoglucosenone, cyclopentanone, or a combination thereof. The organic solvent is removed from the precursor layer to form the positive electrode on the substrate. The polymer binder mixture comprises a polyvinylidene fluoride (PVDF) homopolymer and a copolymer having the formula (1):

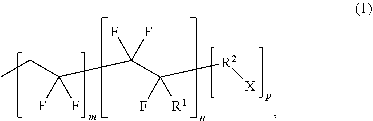

wherein:
m is greater than or equal to 3500 and less than or equal to 18000,
n is greater than or equal to 800 and less than or equal to 7500,
p is 1 or 0,
R¹ is F or a perfluorinated alkyl group,
R² is an alkylene group, and
X is an acidic functional group.

The copolymer may comprise poly(vinylidene fluoride-co-tetrafluoroethylene) (PVDF-TFE), poly(vinylidene fluoride-co-hexafluoropropylene) (PVDF-HFP), a copolymer of vinylidene fluoride, tetrafluoroethylene, and hexafluoropropylene (THV), or a combination thereof.

A weight ratio of the PVDF homopolymer to the copolymer in the polymer binder mixture may be greater than or equal to 1:1 and less than or equal to 3:1.

The precursor mixture may have a solids content of greater than or equal to 50% and less than or equal to 85%.

The method may further comprise preparing a polymer binder solution comprising the polymer binder mixture and the organic solvent. The polymer binder solution may have a solids content of greater than or equal to 4% and less than or equal to 8%. Then, the electroactive positive electrode material may be introduced into the polymer binder solution to form the precursor mixture.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating the positive and negative electrodes and the porous separator.

In the drawings, reference numbers may be reused to identify similar and/or identical elements.

### DETAILED DESCRIPTION

The presently disclosed polymer binder mixtures can be used to manufacture PVDF binder-containing positive electrodes at ambient temperatures using relatively innocuous organic solvents (e.g., γ-valerolactone, GVL), as compared to petrochemical solvents, e.g., N-methyl-2-pyrrolidone (NMP). The polymer binder mixtures comprise a PVDF homopolymer and a copolymer that is formulated to improve the ambient-temperature solubility of the PVDF homopolymer in the organic solvent, e.g., in GVL. The copolymer comprises a copolymer made of vinylidene fluoride (VDF) monomers and at least one perfluorinated olefin monomer.

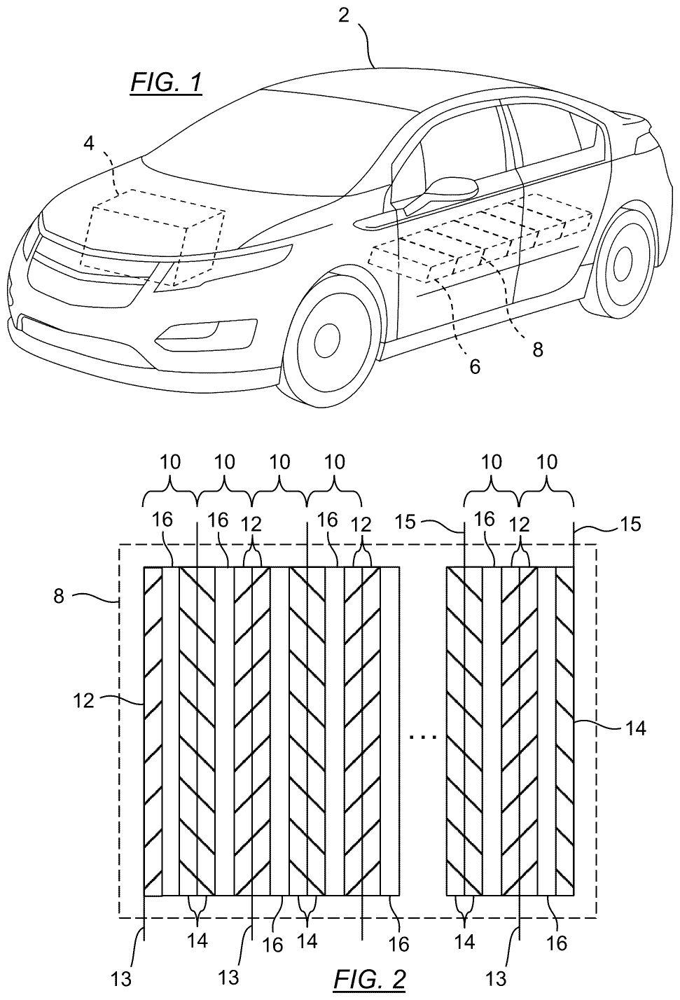

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

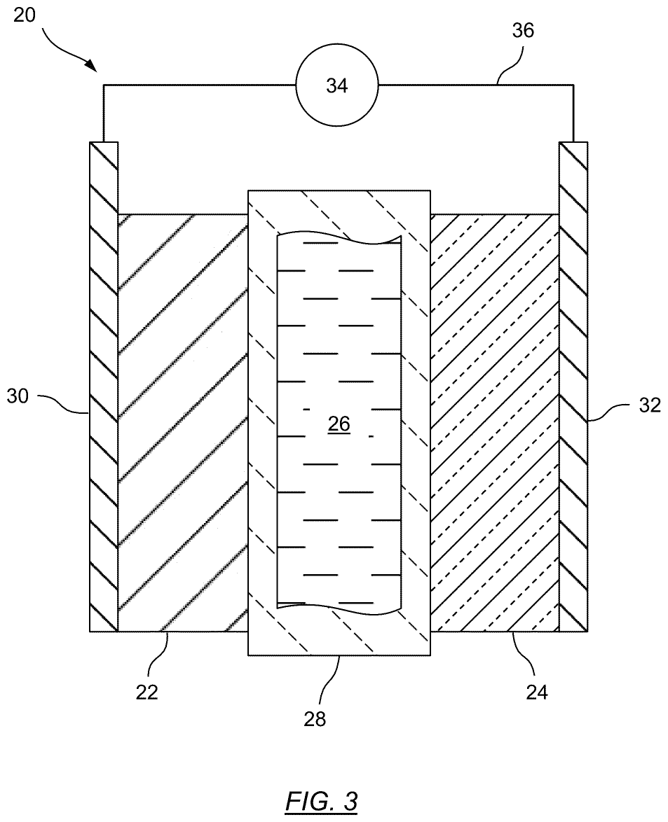

FIG. 3 depicts an electrochemical cell or battery 20 that cycles lithium ions. The battery 20 can generate an electric current during discharge, which may be used to supply power to a load device (e.g., the electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that provides a medium for conduction of lithium ions between the negative electrode 22 and the positive electrode 24. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons from the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The positive electrode 24 is formulated to store and release lithium ions during discharge and charge of the battery 20. The positive electrode 24 may be in the form of a continuous porous layer disposed on the major surface of the positive electrode current collector 32. The positive electrode 24 comprises an electrochemically active (electroactive) material, a polymer binder mixture, and optionally an electrically conductive material. In aspects, the electroactive material of the positive electrode 24 may be a particulate material and particles of the electroactive material of the positive electrode 24 may be intermingled with the polymer binder mixture and the optional electrically conductive material. The positive electrode 24 may have a porosity of greater than or equal to 20% and less than or equal to 50%. The positive electrode 24 may have a thickness of greater than or equal to 30 micrometers (μm), optionally greater than or equal to 50 μm, optionally greater than or equal to 70 μm, or optionally greater than or equal to 100 μm and less than or equal to 500 μm.

The electroactive material of the positive electrode 24 can store and release lithium ions by undergoing a reversible redox reaction with lithium at a higher electrochemical potential than the electrochemically active material of the negative electrode 22 such that an electrochemical potential difference exists between the negative electrode 22 and the positive electrode 24. The electroactive material of the positive electrode 24 may comprise a material that can undergo lithium intercalation and deintercalation or a material that can undergo a conversion reaction with lithium. In aspects where the electroactive material of the positive electrode 24 comprises an intercalation host material that can undergo the reversible insertion or intercalation of lithium ions, the electroactive material of the positive electrode 24 may comprise a lithium transition metal oxide. For example, the electroactive material of the positive electrode 24 may comprise a layered lithium transition metal oxide represented by the formula LiMeO₂ and/or Li₂MeO₃, a layered lithium-rich transition metal oxide represented by the formula Li₁₊ₓMe₁₋ₓO₂ (where 0<x≤0.33), an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). Specific examples of lithium transition metal oxides include LiNi_{1-x-y}CoₓMn_{y}O₂ (NMC), where 0≤x≤1 and 0≤y≤1; LiNi_{1-x-y-z}CoₓMn_{y}Al_{z}O₂ (NCMA), where 0≤x≤1, 0≤y≤1, and 0≤z≤1; LiNi_{1-x-y}CoₓAl_{y}O₂ (NCA), where 0≤x≤1 and 0≤y≤1; LiNiₓMn₁₋ₓO₂ (LNMO), where 0≤x≤1; lithium manganese oxide (LMO) (e.g., Li₍₁₊ₓ₎Mn₂O₄, where 0.1≤x≤1); lithium nickel manganese oxide (LiNi_{0.5}Mn_{1.5}O₄); lithium cobalt oxide (LiCoO₂) (LCO); lithium iron phosphate (LiFePO₄); lithium vanadium phosphate (LiVPO₄); lithium manganese iron phosphate (LiMn₁₋ₓFeₓPO₄, where 0≤x≤1); lithium manganese rich layered oxide (LMR); and combinations thereof. The electroactive material of the positive electrode 24 may constitute, by weight, greater than or equal to 80% and less than or equal to 98%, or optionally less than or equal to 90%, of the positive electrode 24.

The polymer binder mixture is electrochemically inactive and is included in the positive electrode 24 to provide the positive electrode 24 with structural integrity and/or to help the positive electrode 24 adhere to the major surface of the positive electrode current collector 32. The polymer binder mixture comprises a polyvinylidene fluoride (PVDF) homopolymer and a copolymer. A weight ratio of the PVDF homopolymer to the copolymer (PVDF homopolymer:copolymer) in the polymer binder mixture may be greater than or equal to 1:1 and less than or equal to 3:1. The polymer binder mixture may constitute, by weight, greater than or equal to 0.5%, optionally greater than or equal to 1%, or optionally greater than or equal to 2%, and less than or equal to 10%, or optionally less than or equal to 5%, of the positive electrode 24.

The PVDF homopolymer may have the formula —(CH₂CF₂)ₙ—, where n represents the number of repeating monomers in the PVDF homopolymer. The PVDF homopolymer may have a molecular weight of greater than or equal to 500 kilodaltons (kD) and less than or equal to 1500 kD. The PVDF homopolymer may constitute, by weight, greater than or equal to 0.25% and less than or equal to 3.75% of the positive electrode 24. One specific example of a PVDF homopolymer is Solef® 5130 manufactured by Solvay.

The copolymer is included in the polymer binder mixture to help promote dissolution of the PVDF homopolymer in the organic solvent used during manufacture of the positive electrode 24. The copolymer comprises vinylidene fluoride (VDF) monomers and at least one perfluorinated olefin monomer. Examples of perfluorinated olefin monomers include tetrafluoroethylene (TFE) and hexafluoropropylene (HFP). TFE monomers have the formula —(C₂F₄)— and HFP monomers have the formula —CF₂CF(CF₃)—. The copolymer may constitute, by weight, greater than or equal to 0.1% and less than or equal to 2.5% of the positive electrode 24. The copolymer may have a molecular weight of greater than or equal to 500 kilodaltons (kD) and less than or equal to 1500 kD.

In embodiments, the copolymer may be an acid functional polymer and may comprise at least one acidic functional group. Examples of acidic functional groups include carboxyl (—C(═O)OH), sulfo (—S(═O)₂—OH), phosphono (—P(═O)(—OH)₂), nitro (—NO₂), mercapto (—SH), and combinations thereof. In such case, the ion-exchange capacity (IEC) of the copolymer, which represents the number of basic groups that can be neutralized by the copolymer, may be greater than or equal to 0.05 milliequivalents H⁺ per gram (meq H⁺/g) and less than or equal to 5 meq H⁺/g.

The copolymer may have the following formula (1):

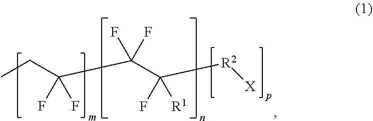

where 3500≤m≤18000, 800≤n≤7500, p is 1 or 0, R¹ is F or a perfluorinated alkyl group, R² is an alkylene group, and X is an acidic functional group. Examples of perfluorinated alkyl groups include trifluoromethyl (—CF₃) and pentafluoroethyl (—C₂F₅). Examples of alkylene groups include methylene (—CH₂—), ethylene (—CH₂—CH₂—), trimethylene (—CH₂—CH₂—CH₂—), tetramethylene, pentamethylene, hexamethylene, vinylene (—HC═CH—), propenylene (—H₂C═C═CH—), propylene (—CH(CH₃)CH₂—), phenylene group (—C₆H₄—), tetrafluorophenylene group, and cyclohexadiene.

In embodiments, the copolymer may comprise poly(vinylidene fluoride-co-tetrafluoroethylene) (PVDF-TFE), poly(vinylidene fluoride-co-hexafluoropropylene) (PVDF-HFP), a copolymer of vinylidene fluoride, tetrafluoroethylene, and hexafluoropropylene (THV), or a combination thereof. One specific commercially available PVDF-TFE copolymer is NEOFLON VT475 manufactured by Daikin Industries, Ltd.

The optional electrically conductive material is electrochemically inactive and may be included in the positive electrode 24 to provide the positive electrode 24 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the positive electrode 24, the optional electrically conductive material may constitute, by weight, greater than 0%, optionally greater than or equal to about 1%, or optionally greater than or equal to about 5% and less than or equal to about 10% of the positive electrode 24.

The negative electrode 22 is formulated to store and release lithium ions to facilitate charge and discharge, respectively, of the battery 20. The negative electrode 22 may be in the form of a continuous layer of material disposed on a major surface of the negative electrode current collector 30. The negative electrode 22 comprises an electrochemically active (electroactive) material (electroactive negative electrode material) that can store and release lithium ions by undergoing a reversible redox reaction with lithium during charge and discharge of the battery 20. Examples of electroactive negative electrode materials include lithium, lithium-based materials (e.g., alloys of lithium and silicon, aluminum, indium, and/or tin), carbon-based materials (e.g., graphite, activated carbon, carbon black, hard carbon, soft carbon, and/or graphene), silicon, silicon-based materials (e.g., alloys of silicon and lithium, tin, iron, aluminum, and/or cobalt), silicon oxide, silicon oxide-based materials (e.g., lithium silicon oxide), tin oxide, aluminum, indium, zinc, germanium, titanium oxide, lithium titanate, and combinations thereof.

In embodiments, the electroactive material of the negative electrode 22 may be a particulate material and particles of the electroactive material of the negative electrode 22 may be intermingled with a polymer binder, a copolymer, and an optional electrically conductive material. The same polymer binders, copolymers, and electrically conductive materials described above with respect to the positive electrode 24 may be included in the negative electrode 22 in substantially the same amounts.

The separator 26 physically separates and electrically isolates the negative electrode 22 and the positive electrode 24 from each other while permitting lithium ions to pass therethrough. The separator 26 has an open microporous structure and may comprise an organic and/or inorganic material. For example, the separator 26 may comprise a polymer. Examples of polymers for the separator 26 include polyolefins (e.g., polyethylene, PE, and/or polypropylene, PP), polyamide (PA), poly(tetrafluoroethylene) (PTFE), polyvinylidene fluoride (PVDF), poly(vinyl chloride) (PVC), and combinations thereof.

The electrolyte 28 is ionically conductive and provides a medium for the conduction of lithium ions between the negative electrode 22 and the positive electrode 24. The electrolyte 28 comprises an organic solvent and a lithium salt in the organic solvent.

The organic solvent may comprise a nonaqueous polar aprotic organic solvent. Non-limiting examples of non-aqueous polar aprotic organic solvents include cyclic carbonates (e.g., ethylene carbonate (EC), propylene carbonate (PC), butylene carbonate (BC), fluoroethylene carbonate (FEC), and vinylene carbonate (VC)); linear carbonates (e.g., dimethyl carbonate (DMC), diethyl carbonate (DEC), ethyl methyl carbonate (EMC)); aliphatic carboxylic esters (e.g., methyl formate, methyl acetate, methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof.

The lithium salt is soluble in the organic solvent and provides a passage for lithium ions through the electrolyte 28. The lithium salt may comprise an inorganic lithium salt, an organic lithium salt, or a combination thereof. Examples of inorganic lithium salts include lithium hexafluorophosphate (LiPF₆), lithium difluorophosphate (LiPO₂F₂), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium tetraphenylborate (LiB(C₆H₅)₄), lithium bis(oxalato)borate (LiB(C₂O₄)₂) (LiBOB), lithium difluoro(oxalato)borate (LiBF₂(C₂O₄)) (LiDFOB), and combinations thereof.

The negative electrode current collector 30 and the positive electrode current collector 32 are electrically conductive and provide an electrical connection between the external circuit 36 and the negative electrode 22 and the positive electrode 24, respectively. In aspects, the negative electrode current collector 30 and the positive electrode current collector 32 may be made of metal and may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

### Methods

The positive electrode 24 may be manufactured by depositing a precursor mixture on a substrate to form a precursor layer, and then drying the precursor layer to form the positive electrode 24 on the substrate. The precursor mixture may be deposited on the substrate via any suitable method. In embodiments, the precursor mixture may be deposited on the substrate using a slot die coating process or a semi-dry extrusion process. In embodiments, the substrate may be made of metal. For example, the substrate may be made of substantially the same material as that of the positive electrode current collector 32. In other embodiments, the substrate may comprise a release film and the positive electrode 24 may be transferred from the substrate to the positive electrode current collector 32 prior to assembly of the battery 20.

The precursor mixture comprises the electroactive positive electrode material, the polymer binder mixture, and the optional electrically conductive material in an organic solvent. The electroactive positive electrode material, the polymer binder mixture, and the optional electrically conductive material may be present in the precursor mixture in substantially the same proportions as that in the positive electrode 24. The electroactive positive electrode material, the polymer binder mixture, and the optional electrically conductive material included in the precursor mixture may have substantially the same composition as the electroactive positive electrode material, the polymer binder mixture, and the optional electrically conductive material included in the positive electrode 24. In particular, the polymer binder mixture included in the precursor mixture comprises the PVDF homopolymer and the copolymer. The precursor mixture may have a solids content of greater than or equal to 50%, optionally greater than or equal to 75%, and less than or equal to 85%.

The organic solvent used to prepare the precursor mixture may comprise γ-valerolactone (also known as gamma-valerolactone or GVL), dihydrolevoglucosenone (also known as Cyrene), cyclopentanone, or a combination thereof. The organic solvent may be considered a “green” solvent, meaning that the organic solvent is relatively innocuous or environmentally friendly, as compared to petrochemical solvents, e.g., N-methyl-2-pyrrolidone (NMP). In particular, GVL has relatively low acute toxicity toward aquatic organisms and is readily biodegradable. The organic solvent may constitute, by weight, greater than or equal to 15% and less than or equal to 50% of the precursor mixture.

The copolymer in the polymer binder mixture is formulated to promote dissolution of the PVDF homopolymer in the organic solvent at ambient temperatures, for example, at temperatures of less than or equal to 30 degrees Celsius (° C.), or optionally less than or equal to 25° C. The PVDF homopolymer is relatively insoluble in GVL and, when mixed with GVL at ambient temperature, the GVL and PVDF homopolymer mixture tends to gel and precipitates of the PVDF homopolymer form. Absent the copolymer, to effectively dissolve the PVDF homopolymer in GVL, the GVL and PVDF homopolymer mixture must be heated to a temperature of greater than or equal to 60° C., which introduces complexity and cost into the positive electrode manufacturing process. The inventors of the present disclosure have discovered that combining the copolymer with the PVDF homopolymer in the precursor mixture used to form the positive electrode 24 ensures that the PVDF homopolymer fully dissolves in the organic solvent (e.g., the GVL) at ambient temperature. Without intending to be bound by theory, it is believed that the copolymer prevents the PVDF homopolymer chains from aligning and/or physically associating with one another in the GVL and thereby prevents gelation of the precursor mixture and precipitation of the PVDF homopolymer therefrom.

The precursor mixture may be prepared by mixing the electroactive negative electrode material, the polymer binder mixture (the PVDF homopolymer and the copolymer), the organic solvent, and the optional electrically conductive material together at ambient temperature. In embodiments, the precursor mixture may be prepared by preparing a polymer binder solution and then mixing the electroactive positive electrode material and the optional electrically conductive material in the polymer binder solution to form the precursor mixture. The polymer binder solution may have a solids content of greater than or equal to 4% and less than or equal to 8%. After the electroactive positive electrode material and the optional electrically conductive material are introduced into the polymer binder solution, the electroactive positive electrode material, the optional electrically conductive material, and the polymer binder solution may be mixed together at ambient temperature, for example, using a planetary mixer or extruder, to form the precursor mixture. In embodiments where the positive electrode 24 comprises the optional electrically conductive material, the precursor mixture may be prepared by preparing the polymer binder solution, introducing the electrically conductive material into the polymer binder solution, and then introducing the electroactive positive electrode material into the polymer binder solution to form the precursor mixture.

After the positive electrode 24 is formed on the substrate, the positive electrode 24 may be assembled into the battery 20 and the negative electrode 22, the positive electrode 24, and the separator 26 may be infiltrated with the electrolyte 28. Then, the negative electrode current collector 30 and the positive electrode current collector 32 may be electrically coupled to the power source 34 such that lithium ions are released from the positive electrode 24 and incorporated into the negative electrode 22.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure. Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

As used herein, the phrase at least one of A, B, and C should be construed to mean a logical (A OR B OR C), using a non-exclusive logical OR, and should not be construed to mean “at least one of A, at least one of B, and at least one of C.” As used herein, the term “and/or” includes combinations of one or more of the associated listed items.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

What is claimed is:

1. A battery that cycles lithium ions, the battery comprising:
a positive electrode comprising an electroactive material and a polymer binder mixture, the polymer binder mixture comprising a polyvinylidene fluoride (PVDF) homopolymer and a copolymer comprising vinylidene fluoride (VDF) monomers and at least one perfluorinated olefin monomer, the copolymer having the formula (1): 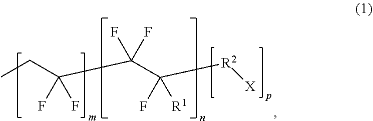
wherein:
m is greater than or equal to 3500 and less than or equal to 18000,
n is greater than or equal to 800 and less than or equal to 7500,
p is 1 or 0,
R¹ is F or a perfluorinated alkyl group,
R² is an alkylene group, and
X is an acidic functional group.

2. The battery of claim 1, wherein the copolymer comprises poly(vinylidene fluoride-co-tetrafluoroethylene) (PVDF-TFE), poly(vinylidene fluoride-co-hexafluoropropylene) (PVDF-HFP), a copolymer of vinylidene fluoride, tetrafluoroethylene, and hexafluoropropylene (THV), or a combination thereof.

3. The battery of claim 1, wherein X is at least one acidic functional group selected from the group consisting of carboxyl (—C(═O)OH), sulfo (—S(═O)₂—OH), phosphono (—P(═O)(—OH)₂), nitro (—NO₂), and mercapto (—SH).

4. The battery of claim 1, wherein the copolymer has an ion-exchange capacity of greater than or equal to 0.05 milliequivalents H⁺ per gram and less than or equal to 5 milliequivalents H⁺ per gram.

5. The battery of claim 1, wherein a weight ratio of the PVDF homopolymer to the copolymer in the polymer binder mixture is greater than or equal to 1:1 and less than or equal to 3:1.

6. The battery of claim 1, wherein the PVDF homopolymer has a molecular weight of greater than or equal to 500 kilodaltons and less than or equal to 1500 kilodaltons, and wherein the copolymer has a molecular weight of greater than or equal to 500 kilodaltons and less than or equal to 1500 kilodaltons.

7. The battery of claim 1, wherein the polymer binder mixture constitutes, by weight, greater than or equal to 0.5% and less than or equal to 5% of the positive electrode.

8. The battery of claim 1, wherein the electroactive material constitutes, by weight, greater than or equal to 80% and less than or equal to 98% of the positive electrode.

9. The battery of claim 1, wherein the positive electrode further comprises an electrochemically inactive, electrically conductive carbon-based material.

10. The battery of claim 1, further comprising:
a negative electrode comprising an electroactive negative electrode material; and
an electrolyte infiltrating the positive electrode and the negative electrode, the electrolyte comprising a nonaqueous polar aprotic organic solvent and a lithium salt in the nonaqueous polar aprotic organic solvent.

11. A battery that cycles lithium ions, the battery comprising:
a positive electrode comprising an electroactive material and a polymer binder mixture, the polymer binder mixture comprising a polyvinylidene fluoride (PVDF) homopolymer and a copolymer comprising poly(vinylidene fluoride-co-tetrafluoroethylene) (PVDF-TFE), poly(vinylidene fluoride-co-hexafluoropropylene) (PVDF-HFP), a copolymer of vinylidene fluoride, tetrafluoroethylene, and hexafluoropropylene (THV), or a combination thereof.

12. The battery of claim 11, wherein a weight ratio of the PVDF homopolymer to the copolymer in the polymer binder mixture is greater than or equal to 1:1 and less than or equal to 3:1.

13. The battery of claim 11, wherein the PVDF homopolymer has a molecular weight of greater than or equal to 500 kilodaltons and less than or equal to 1500 kilodaltons, and wherein the copolymer has a molecular weight of greater than or equal to 500 kilodaltons and less than or equal to 1500 kilodaltons.

14. The battery of claim 11, wherein the copolymer comprises at least one acidic functional group selected from the group consisting of carboxyl (—C(═O)OH), sulfo (—S(═O)₂—OH), phosphono (—P(═O)(—OH)₂), nitro (—NO₂), and mercapto (—SH).

15. The battery of claim 11, wherein the polymer binder mixture constitutes, by weight, greater than or equal to 0.5% and less than or equal to 5% of the positive electrode, and wherein the electroactive material constitutes, by weight, greater than or equal to 80% and less than or equal to 98% of the positive electrode.

16. A method of manufacturing a positive electrode for a battery that cycles lithium ions, the method comprising:
depositing a precursor mixture on a substrate at a temperature of less than or equal to 30 degrees Celsius to form a precursor layer, the precursor mixture comprising an electroactive positive electrode material, a polymer binder mixture, and an organic solvent comprising γ-valerolactone, dihydrolevoglucosenone, cyclopentanone, or a combination thereof, the polymer binder mixture comprising a polyvinylidene fluoride (PVDF) homopolymer and a copolymer having the formula (1): 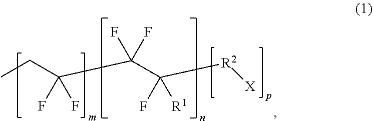
wherein:
m is greater than or equal to 3500 and less than or equal to 18000,
n is greater than or equal to 800 and less than or equal to 7500,
p is 1 or 0,
R¹ is F or a perfluorinated alkyl group,
R² is an alkylene group, and
X is an acidic functional group; and then
removing the organic solvent from the precursor layer to form the positive electrode.

17. The method of claim 16, wherein the copolymer comprises poly(vinylidene fluoride-co-tetrafluoroethylene) (PVDF-TFE), poly(vinylidene fluoride-co-hexafluoropropylene) (PVDF-HFP), a copolymer of vinylidene fluoride, tetrafluoroethylene, and hexafluoropropylene (THV), or a combination thereof.

18. The method of claim 16, wherein a weight ratio of the PVDF homopolymer to the copolymer in the polymer binder mixture is greater than or equal to 1:1 and less than or equal to 3:1.

19. The method of claim 16, wherein the precursor mixture has a solids content of greater than or equal to 50% and less than or equal to 85%.

20. The method of claim 16, further comprising:
preparing a polymer binder solution comprising the polymer binder mixture and the organic solvent, the polymer binder solution having a solids content of greater than or equal to 4% and less than or equal to 8%; and then
introducing the electroactive positive electrode material into the polymer binder solution to form the precursor mixture.
